(19) United States
(12) Patent Application Publication
(10) Pub. No.: US 2015/0074254 A1
(43) Pub. Date: Mar. 12, 2015

(54) CROWD-SOURCED CLUSTERING AND ASSOCIATION OF USER NAMES

(71) Applicant: Sync.me, Tel Aviv (IL)

(72) Inventor: Chen Vinner, Pardesiya (IL)

(73) Assignee: Sync.me, Tel Aviv (IL)

(21) Appl. No.: 14/023,485

(22) Filed: Sep. 11, 2013

(51) Int. Cl. H04L 29/12

(52) U.S. Cl. CPC H04L 61/304
USPC 709/223

(57) ABSTRACT

A method include correlating, for each user among a plurality of users, between multiple different name representations appearing in multiple respective contact lists of the user. A set of user-independent name clusters is derived from the correlated name representations established over the contact lists of the plurality of the users, wherein each name cluster associates the multiple different name representations of a respective name. Information relating to one or more of the users is processed based on the user-independent name clusters.

### FIELD OF THE INVENTION

The present invention relates generally to network communication, and particularly to methods and systems for management of contact information.

### BACKGROUND OF THE INVENTION

Users of communication networks typically create, maintain and use various kinds of contact lists. For example, mobile phone users use address books for storing names, telephone numbers and other contact information.

As another example, user profiles of social network applications have contact lists in which the user maintains contact information of friends, colleagues or other contacts.

Various methods and system for correlating contact lists are known in the art. For example, U.S. Patent Application Publication 2010/0144323, whose disclosure is incorporated herein by reference, describes a contact enrichment system. The system determines whether contacts stored in a mobile device match profiles stored on a social network server. Profiles matching the contacts are used to enrich the contacts by appending information such as images and video to the contacts. The appended information in the contacts are also linked to the source profile so that the contact information may be periodically updated.

As another example, U.S. Pat. No. 8,214,301, whose disclosure is incorporated herein by reference, describes techniques for social network mapping. In one implementation, properties of a user's contacts with two services are analyzed to identify matching contacts.

Contacts may be determined to correspond to the same user when sufficient common properties are found between the contacts. For unmatched contacts following the property analysis, additional processing may be conducted to identify contacts that the unmatched contacts have in common. A number of common contacts found through this processing may be used, alone or in combination, with information regarding common properties to determine when unmatched contacts correspond to the same user.

U.S. Patent Application Publication 2011/004561, whose disclosure is incorporated herein by reference, describes techniques for aggregating contact information. In one implementation, contact information that is associated with a single user and that is obtained from a plurality of services via a network is aggregated. A least one of the services is configured as a social networking service. A user interface is configured to include at least a portion of the aggregated contact information such that the single user is represented above the portion of the aggregated contact information in the user interface.

Chinese Patent Application CN102143485, whose disclosure is incorporated herein by reference, describes a mobile terminal and a method for associating a contact in an address book of the mobile terminal with a user in a social networking site. The method comprises the following steps: acquiring contact information in the address book of the mobile terminal and user information in the social networking site; matching the contact information in the address book of the mobile terminal with the user information in the social networking site; judging whether a matching status of the contact information in the address book and the user information in the social networking site accords with a preset condition of the terminal; and if so, finishing the association of the contact in the address book and the user in the social networking site.

### SUMMARY OF THE INVENTION

An embodiment of the present invention provides a method, which includes correlating, for each user among a plurality of users, correlating between multiple different name representations appearing in multiple respective contact lists of the user. A set of user-independent name clusters is derived from the correlated name representations established over the contact lists of the plurality of the users, wherein each name cluster associates the multiple different name representations of a respective name. Information relating to one or more of the users is processed based on the user-independent name clusters.

In a disclosed embodiment, correlating between the name representations includes detecting that the name representations are associated with a common identifier in the multiple contact lists. Typically, the common identifier includes an e-mail address or a telephone number.

Deriving the name clusters may include assigning confidence levels to respective associations between the name representations in a given name cluster. Additionally or alternatively, deriving the name clusters may include adding an association between first and second name representations to a name cluster only when a confidence level of the association exceeds a predefined threshold.

In disclosed embodiments, the name representations include at least one representation type selected from a group of types consisting of formal names, informal names, nicknames, names in different languages and names having different spelling alternatives. Additionally or alternatively, at least one of the contact lists includes an address book in a mobile communication device of the user or is obtained from a social network profile of the user. Correlating between the name representations may include obtaining at least one of the different contact lists from a mobile communication device of the user.

In some embodiments, deriving the user-independent name clusters includes producing first and second clusters that associate the name representations of a name as applicable to first and second countries, respectively.

In another embodiment, processing the information includes enriching a first contact list of a given user with content obtained from a second contact list of the given user.

In some embodiments, processing the information includes translating text, which includes a name, from a first language to a second language, including translating a first name representation of the name in the first language into a second name representation of the name in the second language. Additionally or alternatively, processing the information includes processing a search query, which includes a first name representation of a name, so as to search for a second name representation of the name. Further additionally or alternatively, processing the information includes decoding voice input, which includes a first name representation of a name, so as to recognize a second name representation of the name.

There is also provided, in accordance with an embodiment of the present invention, apparatus, including a network interface, which is configured to communicate with a network. A processor is configured to access over the network contact lists of users, to correlate, for each user among a plurality of the users, between multiple different name representations appearing in multiple respective contact lists of the user, to derive a set of user-independent name clusters from the correlated name representations established over the contact lists of the plurality of the users, wherein each name cluster associates the multiple different name representations of a respective name, and to process information relating to one or more of the users based on the user-independent name clusters.

There is additionally provided, in accordance with an embodiment of the present invention, a computer software product, including a non-transitory computer-readable medium in which program instructions are stored, which instructions, when read by a processor, cause the processor to correlate, for each user among a plurality of users, between multiple different name representations appearing in multiple respective contact lists of the user, to derive a set of user-independent name clusters from the correlated name representations established over the contact lists of the plurality of the users, wherein each name cluster associates the multiple different name representations of a respective name, and to process information relating to one or more of the users based on the user-independent name clusters.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for crowd-sourced correlation of contact information, in accordance with an embodiment of the present invention;

FIG. 2 is a diagram showing user name representations associated using common identifiers, in accordance with an embodiment of the present invention;

FIG. 3 is a diagram showing crowd-sourced clusters of name representations, in accordance with an embodiment of the present invention;

FIG. 4 is a flow chart that schematically illustrates a method for constructing a crowd-sourced database of name clusters, in accordance with an embodiment of the present invention; and

FIG. 5 is a flow chart that schematically illustrates a method for enriching content of a mobile phone address book using a crowd-sourced database of name clusters, in accordance with an embodiment of the present invention.

### DETAILED DESCRIPTION OF EMBODIMENTS

### Overview

Embodiments of the present invention that are described herein provide improved methods and systems for correlating information from multiple contact lists. The disclosed techniques can be used, for example, for correlating between a user's mobile-phone address book and the contact list in the user's social network profile, and then enriching the address book entries with content obtained from the social network.

One of the challenges in correlating contact list entries is that users tend to write the names of their contacts differently in different contact lists. For example, contact names in a social network profile usually appear as full formal names. In a mobile-phone address book, on the other hand, users often enter nicknames, informal names or abbreviations. Name variations may also include, for example, names written in different languages and names having different spelling alternatives. All such variations are referred to herein as name representations, or simply representations for brevity.

The disclosed techniques use crowd-sourcing methods to reliably associate between different representations of the same name. These associations can then be used for correlating contact-list entries, notwithstanding the variations in contact names.

In some embodiments, a correlation server constructs and maintains a database of crowd-sourced, user-independent name clusters. Each name cluster associates between multiple different representations of a certain name. The name clusters are formed by scanning and correlating contact-list entries of a large number of users. Each name cluster is derived from multiple contact-list entries of multiple users, and is not directly related to any individual user.

In a typical process, the correlation processor scans the contact lists of multiple users, and finds correlations between different name representations using common identifiers. For example, upon detecting that different contact names in two different contact lists correspond to the same phone number or e-mail address, the correlation processor may deduce that the contact names are different representations of the same name. The correlation accumulates correlations of this sort over a large number of contact-list entries of many users. The correlation processor then clusters the above correlations, so as to produce a set of user-independent name clusters.

The correlation processor may construct the database of name clusters by crowd-sourcing contact lists from different applications (e.g., both social networks and mobile device address books), or from only a single application. In a disclosed embodiment, the correlation processor produces the name clusters by crowd-sourcing only address books of multiple mobile devices.

The disclosed crowd-sourced name clusters can be used for various purposes. Example applications include enriching one contact list with content obtained from another contact list, translation between languages that includes reliable translation of names, processing of search queries that accounts for different name representations, decoding of voice commands that recognizes different name representations, among others.

Since each name cluster is based on a large number of correlated contact-list entries of many users, the confidence level of the association between name representations is considerably higher than the confidence level that is achievable for any individual user. As a result, systems and applications that use such name clusters can achieve high correlation performance—e.g., small probability of missed and/or false correlations.

### System Description

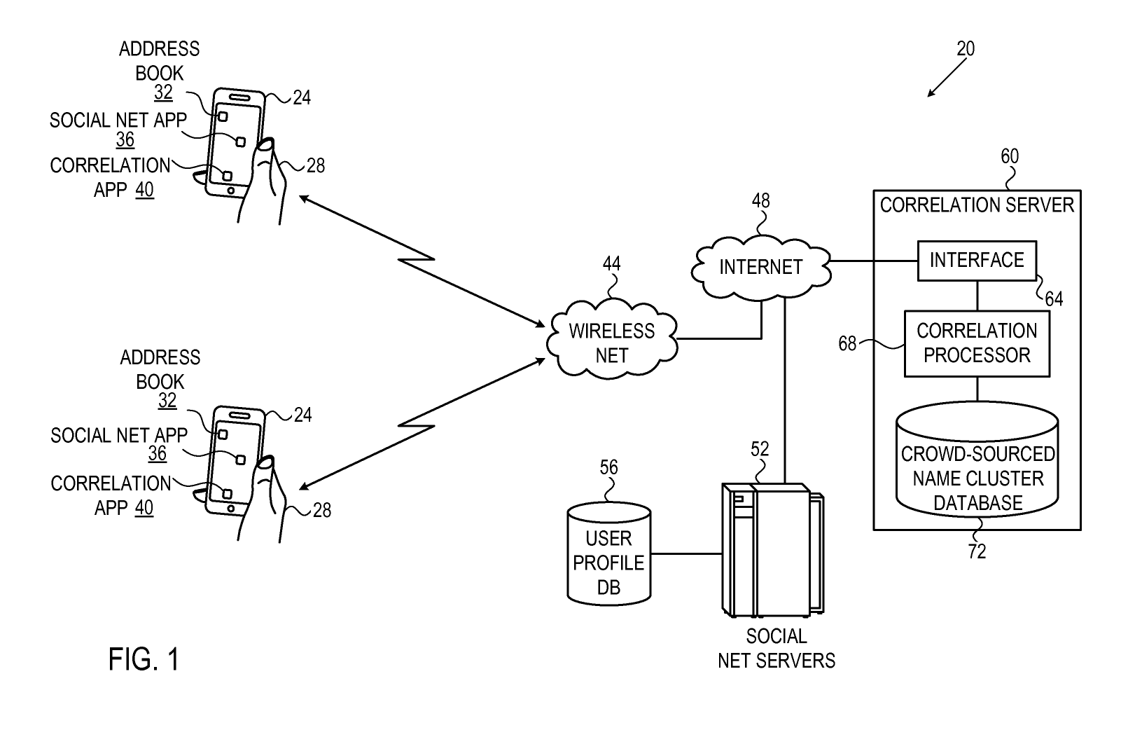

FIG. 1 is a block diagram that schematically illustrates a system 20 for crowd-sourced correlation of contact information, in accordance with an embodiment of the present invention. In system 20, multiple users 28 operate communication devices, such as mobile phones 24. Phones 24 communicate over a wireless network 44 (e.g., a cellular or Wi-Fi network) that in connected to a Wide Area Network (WAN) 48, such as the Internet.

Each user 28 runs a number of applications on his mobile phone, in which he maintains respective contact lists. In the present example, phone 24 has an address book 32 that lists contact names and their phone numbers. In addition, phone 24 runs a social-network application such as Facebook® or LinkedIn. The social network profile of the user typically comprises a list of contacts. Typically, social network application 36 communicates with one or more social network servers 52, which store the user profiles in a user profile database 56.

The embodiments described herein refer mainly to mobile phones as the platform used by users 28 for running applications, and in particular for managing contact lists. In alternative embodiments, however, the disclosed techniques can be used with any other suitable kind of communication and/or computing device, such as mobile or tablet computers, or Personal Digital Assistants (PDAs).

The embodiments described herein refer mainly to mobile-phone address books and social network contact lists. Generally, however, the disclosed techniques can be used with any other suitable type of contact lists. Depending on the application, contacts may also be referred to as connections, friends, or any other suitable term. Each contact list comprises entries, each entry comprising a contact name, contact information (e.g., one or more phone numbers and/or e-mail addresses), and optionally additional information such as address, company name or picture. As will be described in detail below, the disclosed techniques can also be carried out using only address books of mobile devices, without involving any social network information.

For various applications and purposes, it is highly desirable to be able to correlate contacts from different contact lists of a given user 28. Contact correlation enables, for example, enriching address book 32 of phone 24 with information that is obtained from the profiles of contacts that appear in the social-network profile of the user.

In some embodiments, phone 24 runs a correlation application 40 that correlates between the different contact lists of user 28 (in the present example, between address book 32 and the contact list of social network application 36). Correlation application 40 communicates with a correlation server 60, which typically performs the correlation tasks described herein. Correlation server 60 comprises a network interface 64 for connecting to network 48, and a correlation processor 68 that carries out the disclosed techniques. As will be explained in detail below, processor 68 constructs and maintains a crowd-sourced name cluster database 72.

The system configuration shown in FIG. 1 is an example configuration that is chosen purely for the sake of conceptual clarity. In alternative embodiments, any other suitable system configuration can be used. For example, the description that follows assumes that the disclosed techniques are carried out by correlation server 60. Alternatively, however, certain parts of the disclosed techniques can be performed by application 40 running on the processor of phone 24. The disclosed techniques can be divided between server 60 and application 40 in any desired manner.

The various elements of system 20 may be implemented using hardware/firmware, such as in one or more Application-Specific Integrated Circuit (ASICs) or Field-Programmable Gate Array (FPGAs). Alternatively, some system elements, such as functions of processor 68, may be implemented in software or using a combination of hardware/firmware and software elements. Database 72 may be stored on any suitable storage device or memory. In some embodiments, processor 68 comprises a general-purpose computer, which is programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

### Crowd-Sourced Clustering of Name Representations

One of the prime challenges in correlating contact lists is the variability in the representation of contact names. While telephone numbers and e-mail addresses are necessarily exact, the names of contacts can be entered by users in various ways. For example, a user may enter the full formal name of a contact, an informal name, a nickname, an abbreviation of the name, the name in any of several possible languages, the name in any of several possible spelling options, or any other suitable kind of variation. In the context of the present patent application and in the claims, any and all such variations of a name are referred to as name representations.

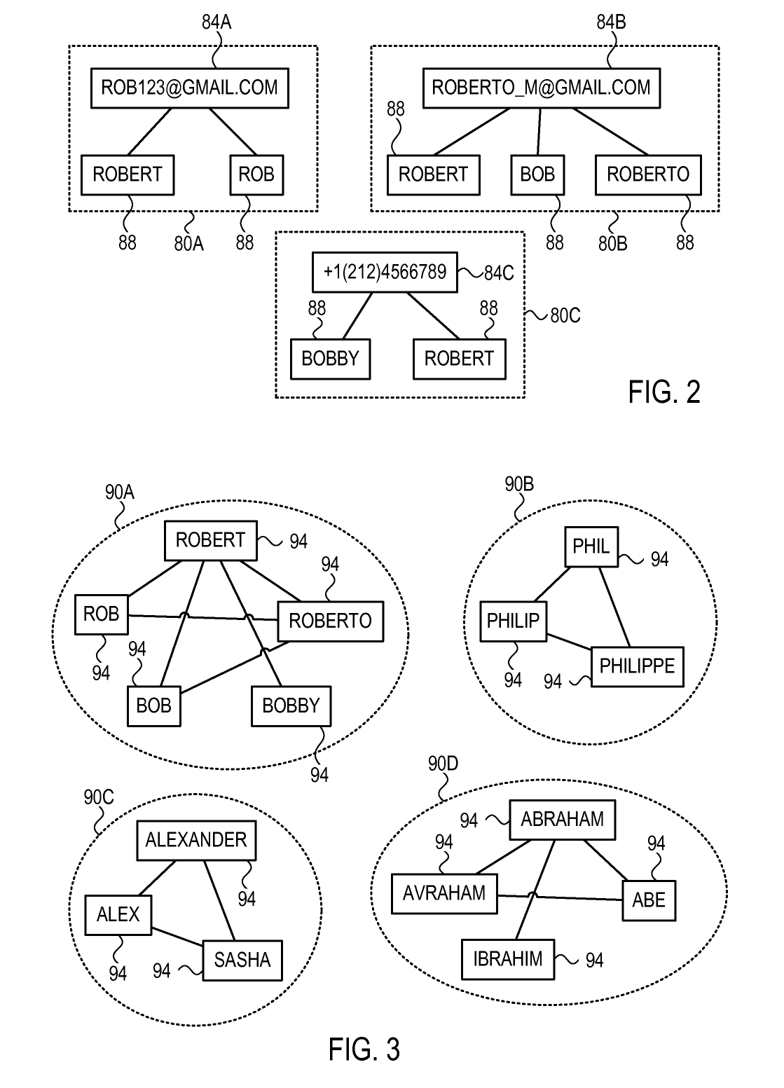

In some embodiments, processor 68 overcomes these difficulties in name correlation by constructing name cluster database 72, which associates between different representations of names. Processor 68 constructs database 72 in a two-stage process: In the first stage, processor 68 scans the various contact lists of users 28 and finds correlations between name representations based on common identifiers, such as phone numbers and e-mail addresses. Then, processor 68 constructs name clusters from the above correlations. The first and second stages of this process are demonstrated in FIGS. 2 and 3 below, respectively.

FIG. 2 is a diagram showing user name representations 88 associated using common identifiers 84A . . . 84C, in accordance with an embodiment of the present invention. In this stage of the correlation process processor 68 scans address books 32 and the social network contact lists of user 28, and tries to correlate different name representations using common identifiers.

The example of FIG. 2 refers to different representations 88 of the name “Robert.” When scanning the address books and social network contact lists, processor 68 finds that the name representation “Robert” is listed in some social network contact list with the e-mail address “rob123@gmail.com,” and that the name representation “Rob” is listed in some address book (not necessarily of the same user) with the same e-mail address rob123@gmail.com.” This example is shown at the top-left of the figure. Based on this identification, processor 68 concludes with high confidence that “Robert” and “Rob” are different representations of the same name. Referring to the top-right of the figure, processor also finds that the name representation “Robert” is listed in some social network contact list with the e-mail address “Roberto_m@gmail.com,” that the name representation “Bob” is listed in some address book with the same e-mail address, and that this same e-mail address is listed in yet another contact list (not necessarily of the same user) with the name representation “Roberto.” Based on this identification, processor 68 concludes with high degree of confidence that “Robert,” “Bob” and “Roberto” are different representations of the same name.

Referring to the bottom of the figure, processor 68 additionally finds that the name representation “Robert” is listed in some social network contact list as having the phone number “+1(212)4566789,” and that the name representation “Bobby” is listed in some address book (not necessarily of the same user) with the same phone number. This identification enables processor 68 to conclude that “Robert” and “Bobby” are again different representations of the same name.

Typically, processor 68 carries out the correlation process of FIG. 2 for many different names and over a large number of contact lists of many users. The outcome of this stage is a large collection of correlations such as correlations 84A . . . 84C. Note, however, that the correlations at this stage are isolated from one another. For example, at this stage processor 68 is unaware that “Rob” and “Bob” are representations of the same name, because one belongs to correlation 84A and the other belongs to correlation 84B.

FIG. 3 is a diagram showing the second stage of the correlation process, in accordance with an embodiment of the present invention. In this second, processor 68 merges the identifier-based correlations (e.g., correlations 84A . . . 84C of FIG. 2) to form crowd-sourced clusters 90A . . . 90D of name representations 94. Cluster 90A, for example, associated all the known representations of the name “Robert,” and is created by merging correlations 84A . . . 84C and possibly others. Processor 68 merges the identifier-based correlations of other names in a similar manner, to produce clusters 90B . . . 90D. The name clusters are stored in database 72.

In various embodiments, processor 68 may perform the clustering process in different ways and different orders. In an example embodiment, although not necessarily, processor 68 forms a new cluster starting with a name representation originating from a social network contact list, because such an entry is more likely to be written as a full formal name.

The example of FIG. 3 is highly simplified for the sake of clarity. Real-life implementations of database 72 will typically comprise hundreds of clusters, and each cluster may comprise any desired number of name representations.

The example name clusters shown in FIG. 3 demonstrate the powerful way in which the different name representations of each name are found and associated in database 72. The name clusters associate, for example, between formal names and informal names (e.g., “Robert” and “Bob”), between names in different languages (e.g., “Philip” and “Philippe”), as well as between names and nicknames (e.g., “Alexander” and “Sasha”).

This powerful form of clustering is possible because it is calculated jointly over a large number of contact lists of many users. As such, the clusters associate between name representations even if they are never used in the context of any individual user. For example, the representations “Roberto” and “Bobby” may never be used to describe the same user, but since they were both found to be associated with “Robert,” they are also associated with one another. Clustering of this sort is only possible to implement using crowd-sourcing.

As can be appreciated, name clusters 90A . . . 90D are user-independent, i.e., they are not related directly to any specific user. The dependence on identifiers (e.g., e-mail addresses and phone numbers) is used only in the first stage of the process, and is typically discarded when merging the identifier-based correlations to form the name clusters.

In some embodiments, the clustering process of FIGS. 2 and 3 is on-going. In other words, processor 68 keeps scanning the various contact lists on a regular basis, finds new identifier-based correlations and updates the name clusters accordingly. Updates may occur, for example, when the processor scans new contact lists or new users, or when a user updates a contact list.

In some embodiments, when performing the clustering process, processor 68 assigns quantitative confidence levels to the associations between name representations. The confidence level of a given association is indicative of the likelihood that the name representations indeed correspond to the same name. The confidence level may be calculated, for example, depending on the number of identifier-based correlations that indicate this association. For example, if processor 68 finds a large number of identifier-based correlations between “Robert” and “Rob,” then this association will have a high confidence level. A correlation that occurs rarely (e.g., only once) will receive a low confidence level.

In some embodiments, processor 68 includes a certain correlation in the clustering process only if the confidence level of the association exceeds a predefined threshold. Correlations that are rare or otherwise have low confidence may be discarded.

In some embodiments, processor 68 performs separate clustering for correlations pertaining to different countries. For example, some correlations between name representations may be applicable in one country but not in another. The clustering process may take these geographical differences into account. Processor 68 may identify the geographical context of a certain correlation, for example, by the country-of-origin of the common identifier (e.g., by the prefix of a common phone number). In an example embodiment, for a particular name, processor 68 may create different clusters for English-speaking countries and for Spanish-speaking countries.

In the example above, the clustering process uses two types of contact lists (address book and social-network contact list). Alternatively, however, a similar process can be performed using more than two types of contact lists, or using a single type of contact list (e.g., using only address books or using only social-network contact lists.)

As noted above, in some embodiments processor 68 constructs the database of name clusters based only on mobile phone address books, regardless of any social network profiles. In an example embodiment of this sort, processor 68 scans the address books of multiple users, and associate contact names to one another using common identifiers such as phone numbers and e-mail addresses. This stage produces associations between name representations, such as the ones shown in FIG. 2 above. In each such association, processor 68 finds the name representation that occurs most frequently. This name is referred to as POPULAR_NAME. Processor 68 forms the name clusters by adding to the name cluster each name that differs from POPULAR_NAME, but connects it to POPULAR_NAME in the cluster.

In an embodiment, processor 68 sets a certain minimum threshold over the common identifiers (e.g., names and e-mail addresses used for associating different name representations). In other words, an association will be formed only if the common identifier is encountered a sufficient number of times (e.g., five times) in the crowd-sourced address books.

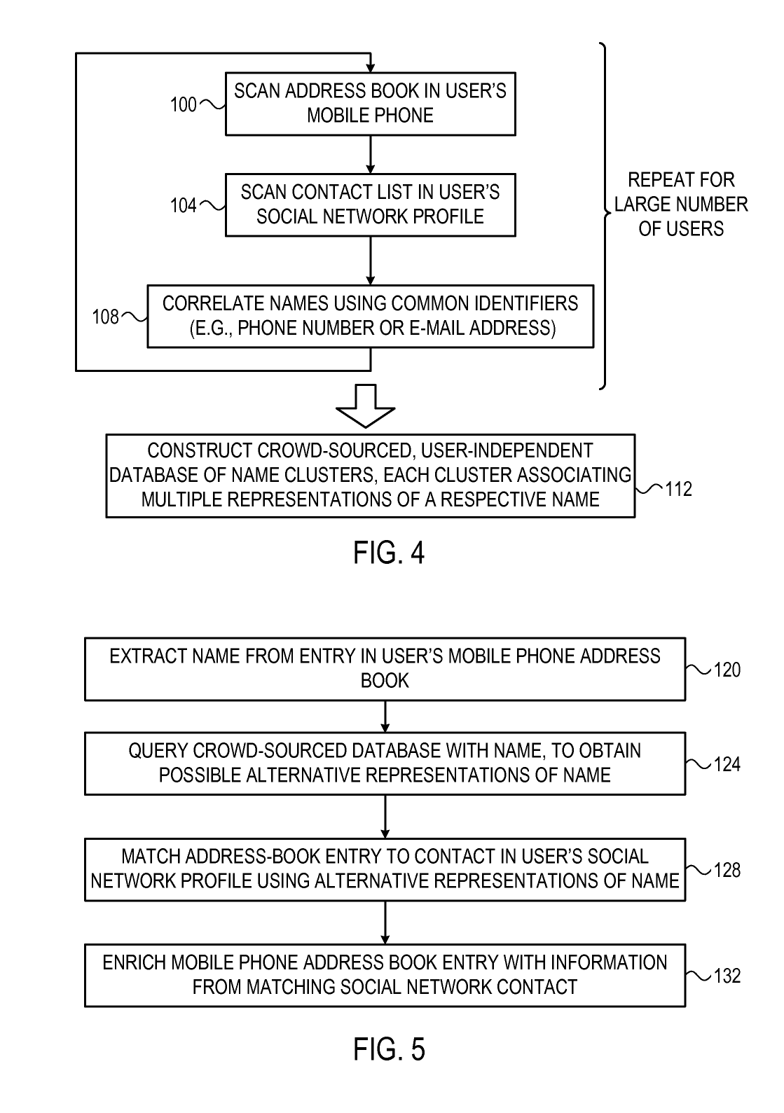

FIG. 4 is a flow chart that schematically illustrates a method for constructing crowd-sourced database 72, in accordance with an embodiment of the present invention. The method begins with processor 68 of server 60 scanning the address book in a user's mobile phone, at a first scanning step 100. In scanning the address book, processor extracts from each entry the contact name and the corresponding identifiers (e.g., phone number and/or e-mail address). At a second scanning step 104, processor 68 scans the user's social-network contact list, and similarly extracts contact name and the corresponding identifier(s) from each entry. The scanning process is repeated over multiple contact lists of multiple users.

The output of steps 100 and 104 is a large collection of pairs [name representation, identifier]. Typically, there is no distinction in this collection between the contact lists from which the pairs originated.

Processor 68 scans the pairs and correlates name representations that correspond to a common identifier, at an identifier-based correlation step 108. An example output of this step is shown in FIG. 2. Processor 68 converts the identifier-based correlations into a set of crowd-sourced user-independent name clusters, at a clustering step 112. An example output of this step is shown in FIG. 3. Processor 68 may repeat the process of FIG. 4 so as to update database 72, e.g., continuously, periodically or in response to predefined triggering events.

### Example Applications of Crowd-Sourced Name Clustering

The set of name clusters stored in database 72 can be used for various purposes and applications. In one example application, processor 68 enriches a user's mobile phone address book with content that is retrieved from the social network.

FIG. 5 is a flow chart that schematically illustrates a method for enriching content of a mobile phone address book using crowd-sourced database 72 of name clusters, in accordance with an embodiment of the present invention. The method begins with processor 68 extracting a contact name from an entry in the mobile phone address book of a certain user, at a name extraction step 120.

Processor 68 queries database 72 with the extracted name, at a querying step 124, so as to obtain the various alternative representations of this name. Processor 68 then attempts to find a matching contact in the social-network contact list of the user, at a matching step 128. In this matching process, processor 68 uses the multiple different name representations obtained at step 124. Therefore, the likelihood of finding a match is high, even though the contact name may be entered differently in the two contact lists. In case of an uncertain match or in case of multiple possible matches, processor 68 may request the user to verify the suggested match via application 40.

Having found a matching entry in the social-network contact list, processor 68 enriches the address-book entry with content obtained from the social network, at an enrichment step 132. For example, processor 68 may access the social network profile of the contact in question and obtain the content from that profile. Enriched content may comprise, for example, a picture of the contact, additional information regarding the contact that does not exist in the address book, or updated information that supersedes existing information in the address book.

The method of FIG. 5 refers to a single contact, for the sake of clarity. Typically, this method is repeated for multiple contacts in the user's address book.

In an alternative embodiment, the name clusters in database 72 can be used for automatic translation from a source language to a destination language. In this sort of application, a translation engine may identify in the original text a name in the source language, and query database 72 to obtain the representation of this name in the destination language. The translation engine can then translate the text, including translating the name to the proper representation in the destination language.

In another embodiment, the name clusters in database 72 can be used for enhancing the performance of a search engine. In this kind of application, a search engine may identify a name in a search query it is requested to perform. The search engine may query database 72 to obtain alternative representation of this name, and then search for the alternative representations, as well. This technique is able to enhance the search quality considerably.

In yet another embodiment, the name clusters in database 72 can be used for enhancing the performance of a voice command application such as Apple Siri, or a voice recognition application in general. In this embodiment, a voice recognition engine may identify a name in voice input it is requested to decode. The voice recognition engine may query database 72 to obtain alternative representation of that name, and then perform decoding (e.g., voice command recognition) for the alternative representations, as well.

Further alternatively, the name clusters in database 72 can be used for any other suitable purpose.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
for each user among a plurality of users, correlating between multiple different name representations appearing in multiple respective contact lists of the user;
deriving a set of user-independent name clusters from the correlated name representations established over the contact lists of the plurality of the users, wherein each name cluster associates the multiple different name representations of a respective name; and
processing information relating to one or more of the users based on the user-independent name clusters.

2. The method according to claim 1, wherein correlating between the name representations comprises detecting that the name representations are associated with a common identifier in the multiple contact lists.

3. The method according to claim 2, wherein the common identifier comprises an e-mail address or a telephone number.

4. The method according to claim 1, wherein deriving the name clusters comprises assigning confidence levels to respective associations between the name representations in a given name cluster.

5. The method according to claim 1, wherein deriving the name clusters comprises adding an association between first and second name representations to a name cluster only when a confidence level of the association exceeds a predefined threshold.

6. The method according to claim 1, wherein the name representations comprise at least one representation type selected from a group of types consisting of formal names, informal names, nicknames, names in different languages and names having different spelling alternatives.

7. The method according to claim 1, wherein at least one of the contact lists comprises an address book in a mobile communication device of the user.

8. The method according to claim 1, wherein at least one of the contact lists is obtained from a social network profile of the user.

9. The method according to claim 1, wherein correlating between the name representations comprises obtaining at least one of the different contact lists from a mobile communication device of the user.

10. The method according to claim 1, wherein deriving the user-independent name clusters comprises producing first and second clusters that associate the name representations of a name as applicable to first and second countries, respectively.

11. The method according to claim 1, wherein processing the information comprises enriching a first contact list of a given user with content obtained from a second contact list of the given user.

12. The method according to claim 1, wherein processing the information comprises translating text, which comprises a name, from a first language to a second language, including translating a first name representation of the name in the first language into a second name representation of the name in the second language.

13. The method according to claim 1, wherein processing the information comprises processing a search query, which comprises a first name representation of a name, so as to search for a second name representation of the name.

14. The method according to claim 1, wherein processing the information comprises decoding voice input, which comprises a first name representation of a name, so as to recognize a second name representation of the name.

15. Apparatus, comprising:
a network interface, which is configured to communicate with a network; and
a processor, which is configured to access over the network contact lists of users, to correlate, for each user among a plurality of the users, between multiple different name representations appearing in multiple respective contact lists of the user, to derive a set of user-independent name clusters from the correlated name representations established over the contact lists of the plurality of the users, wherein each name cluster associates the multiple different name representations of a respective name, and to process information relating to one or more of the users based on the user-independent name clusters.

16. The apparatus according to claim 15, wherein the processor is configured to correlate between the name representations by detecting that the name representations are associated with a common identifier in the multiple contact lists.

17. The apparatus according to claim 16, wherein the common identifier comprises an e-mail address or a telephone number.

18. The apparatus according to claim 15, wherein the processor is configured to assign confidence levels to respective associations between the name representations in a given name cluster.

19. The apparatus according to claim 15, wherein the processor is configured to add an association between first and second name representations to a name cluster only when a confidence level of the association exceeds a predefined threshold.

20. The apparatus according to claim 15, wherein the name representations comprise at least one representation type selected from a group of types consisting of formal names, informal names, nicknames, names in different languages and names having different spelling alternatives.

21. The apparatus according to claim 15, wherein at least one of the contact lists comprises an address book in a mobile communication device of the user.

22. The apparatus according to claim 15, wherein at least one of the contact lists is obtained from a social network profile of the user.

23. The apparatus according to claim 15, wherein the network interface is configured to receive at least one of the different contact lists from a mobile communication device of the user.

24. The apparatus according to claim 15, wherein the processor is configured to produce first and second clusters that associate the name representations of a name as applicable to first and second countries, respectively.

25. The apparatus according to claim 15, wherein the processor is configured to enrich, based on the user-independent name clusters, a first contact list of a given user with content obtained from a second contact list of the given user.

26. The apparatus according to claim 15, wherein the processor is configured to translate, based on the user-independent name clusters, text that comprises a name from a first language to a second language, including translating a first name representation of the name in the first language into a second name representation of the name in the second language.

27. The apparatus according to claim 15, wherein the processor is configured to process, based on the user-independent name clusters, a search query that comprises a first name representation of a name, so as to search for a second name representation of the name.

28. The apparatus according to claim 15, wherein the processor is configured to decode, based on the user-independent name clusters, voice input that comprises a first name representation of a name, so as to recognize a second name representation of the name.

29. A computer software product, comprising a non-transitory computer-readable medium in which program instructions are stored, which instructions, when read by a processor, cause the processor to correlate, for each user among a plurality of users, between multiple different name representations appearing in multiple respective contact lists of the user, to derive a set of user-independent name clusters from the correlated name representations established over the contact lists of the plurality of the users, wherein each name cluster associates the multiple different name representations of a respective name, and to process information relating to one or more of the users based on the user-independent name clusters.
